(19) United States
(12) Patent Application Publication
(10) Pub. No.: US 2019/0141788 A1
(43) Pub. Date: May 9, 2019

(54) Pre-Heating Dual Heater With Improved In-Rush Performance

(71) Applicant: nVent Services GmbH, Schaffhausen (CH)

(72) Inventors: Mohammad Kazemi, San Jose, CA (US); Linda D.B. Kiss, San Mateo, CA (US)

(21) Appl. No.: 16/180,803

(22) Filed: Nov. 5, 2018

Related U.S. Application Data
(60) Provisional application No. 62/581,173, filed on Nov. 3, 2017.

(51) Int. Cl. H05B 1/02; H05B 3/06; H05B 3/18; H05B 3/56

(52) U.S. Cl. CPC H05B 1/0291; H05B 3/06; H05B 2203/035; H05B 3/56; H05B 2203/02; H05B 3/18

(57) ABSTRACT

An electric heating cable is provided with dual heaters, including first and second heating cables encased in at least one polymer jacket. The first heating cable generates thermal energy to heat an object in contact with the exterior surface of the dual-heater cable, and the second heating cable is positioned to pre-heat the first heating cable in order to reduce or eliminate inrush current in the first heating cable when the first heating cable is energized. The first heating cable can be a self-regulating heating cable, and can have a core of positive temperature coefficient (PTC) material encapsulating two bus wires. The second heating cable can be a constant-wattage heating cable disposed between the bus wires; the PTC material can form a channel in which the second heating cable is disposed. Control circuitry energizes the second heating cable for a pre-heating time before energizing the first heating cable.

### CROSS-REFERENCE TO RELATED APPLICATIONS

This application is a non-provisional claiming the benefit of U.S. Prov. Pat. App. Ser. No. 62/581,173, filed under the same title on Nov. 3, 2017, and incorporated fully herein by reference.

### BACKGROUND

In sub-freezing climates, snow and ice accumulation on surfaces can cause injury to persons and property, affecting all types of structures that are exposed to the environment. In particular, roadways, driveways, sidewalks, and roofs and gutters of buildings are at risk of damage and can harbor dangerous conditions when covered in snow or ice. Additionally, there is significant risk associated with working at certain worksites such as oil platforms and ships with exposed decks and passageways in freezing polar regions. Snow-melting and de-icing systems exist for applying heat to the snow and ice or to the covered surfaces, referred to herein as “heated surfaces.” The thermal energy melts the snow and ice and eliminates the associated hazards.

Typically, an electronic device is subject to large current flows, well above steady state current flow for the device, when first turned on. These large current flows are commonly referred to as in-rush current. In-rush current can occur due, in part, to filaments or other electric current paths in the electronic device that, at cooler temperatures, exhibit a lower resistance than would be exhibited at warmer temperatures. As current flows through a given path, the path will begin to generate heat and will warm up, thereby increasing the resistance of the path, and the amplitude of the current flow will stabilize as temperature and resistance stabilizes. If the in-rush current exceeds the current handling capability of the electronic device, portions of the electronic device may overheat, potentially causing the electrical device to malfunction or break down.

This problem is exacerbated when an electronic device must be started in low ambient temperature environments. Lower ambient temperatures contribute to lower electrical path resistance at start-up of the electronic device, which in turn increases the amplitude of in-rush current.

It is within this context that embodiments of the present disclosure arise.

### SUMMARY

A dual heating cable may include a self-regulating (SR) heating cable having first and second conductors that are encapsulated within a positive temperature coefficient (PTC) conductive (e.g., electrically conductive) polymer, and may further include a constant wattage (CW) heating cable that is disposed proximally to the first and second conductors. The CW heating cable may include third and fourth conductors separated via a dielectric material. In other embodiments, the CW heating cable may include a single conductor instead of two conductors. The resistances of the third and fourth conductors may be the same in some embodiments, and may be different in other embodiments. A sheath may surround the third and fourth conductors and may be separated from the third and fourth conductors by the dielectric material, and may provide environmental protection for the CW heating cable. A first thin polymer jacket may surround the SR heating cable, and the CW heating cable. The CW heating cable may be disposed in an air gap formed by the PTC conductive polymer of the SR heating cable and the first thin polymer jacket. A ground layer may surround the first thin polymer jacket, which may serve as an electrical earth ground for the dual heating cable and may also serve to transfer heat around the circumference of the dual heating cable. The ground layer may be, for example, a metallic foil wrap or an assembly of small strands of drain wires. A second thin polymer jacket may surround the ground layer. The second thin polymer jacket may include reinforcing fibers to provide environmental protection.

The CW heating cable may be electrically coupled to a power supply, and, when receiving electrical power from the power supply, may radially generate heat, thereby heating the PTC conductive polymer of the SR heating cable. The constant wattage heating cable may heat the PTC conductive polymer as part of a pre-heating process in order to increase the resistance (e.g., electrical resistance) of the PTC conductive polymer of the SR heating cable. Upon the termination of the pre-heating process (e.g., by cutting off power to the CW heating cable), power may be supplied to the first and second conductors of the SR heating cable. In this way, inrush current experienced by the SR heating cable when energized in low ambient temperature conditions may be reduced, compared to circumstances in which pre-heating is not performed.

Thus, in one aspect, the invention is an apparatus including a dual-heater heating cable including: a first heating cable that includes first and second conductors and heats an area external to the dual-heater heating cable by converting an electric current applied to the first conductor into thermal energy; and, a second heating cable that includes third and fourth conductors, the second heating cable being interposed between the first and second conductors of the first heating cable. The first heating cable can be a self-regulating heating cable, and the second heating cable can be a constant wattage heating cable. The first heating cable can include conductive polymer material that encapsulates the first and second conductors and that electrically couples the first and second conductors together. The second heating cable can be disposed in a channel of the conductive polymer material. The dual-heater heating cable can further include: a first polymer jacket surrounding the first heating cable and the second heating cable; a ground layer surrounding the first polymer jacket; and, a second polymer jacket surrounding the ground layer and forming an exterior surface of the dual-heater heating cable.

The apparatus can further include power controller circuitry that electrically connects to a power supply and to the first and second heating cables, the power controller circuitry configured to provide power to the second heating cable for a predetermined amount of time before providing power to the first heating cable. The predetermined amount of time can be selected to cause the second heating cable to heat the first heating cable to a threshold temperature that prevents an inrush current within the first heating cable when the first heating cable is energized. The power controller circuitry can include or connect to processor circuitry configured to: at a start-up time, cause the power controller circuitry to provide power to the second heating cable; while power is provided to the second heating cable, determine whether the predetermined amount of time has elapsed from the start-up time; and, responsive to a determination that the predetermined amount of time has elapsed, cause the power controller circuitry to disconnect power from the second heating cable and cause the power controller circuitry to provide power to the first heating cable.

The first heating cable can be a self-regulating heating cable including an electrically conductive positive temperature coefficient (PTC) material that encapsulates and spaces apart the first and second conductors and converts at least a portion of an electric current flowing between the first conductor and the second conductor into thermal energy by resistive heating, and the second heating cable heats the PTC material to a steady-state temperature associated with a resistance of the PTC material that enables the first heating cable to maintain a steady-state current without receiving an inrush current that exceeds the steady-state current. The second heating cable can be a constant wattage heating cable positioned to emit heat onto the PTC material, and including a dielectric material encapsulating the third and fourth conductors and a sheath disposed over the dielectric material. The dual-heater heating cable can further include a first polymer jacket surrounding the first heating cable and the second heating cable; the second heating cable can be disposed in an air gap between the PTC material and the first polymer jacket.

A portion of the PTC material extending between the first conductor and the second conductor can define or form a channel, and the second heating cable can be disposed at least partially within the channel. The dual-heater cable can be sufficiently flexible so as to be bent into a serpentine or helical orientation to heat an object external to the dual-heater cable.

The apparatus can further include processor circuitry in electronic communication with the power controller circuitry, and a non-transitory computer readable storage medium that is accessible by the processor circuitry, that stores a time threshold value representing a duration that the second heating cable is energized in order to heat the PTC material to the steady-state temperature, and that further stores computer-readable instructions that the processor circuitry executes to: at a start-up time, cause the power controller circuitry to provide power to the second heating cable; while power is provided to the second heating cable, determine whether a time elapsed from the start-up time is equal to or greater than the time threshold value; and, responsive to a determination that the time elapsed is equal to or greater than the time threshold value, cause the power controller circuitry to disconnect power from the second heating cable, and cause the power controller circuitry to provide power to the first heating cable.

In another aspect, the invention is a dual-heater heating cable including: a first heating cable including a self-regulating core that converts an electric current applied to the first heating cable into thermal energy; a second heating cable positioned to heat the core of the first heating cable; and, at least one polymer jacket surrounding the first heating cable and the second heating cable. The second heating cable can be a constant wattage heating cable positioned to emit heat onto the core and including at least one conductor, a dielectric material encapsulating the at least one conductor, and a sheath disposed over the dielectric material. The core of the first heating cable can include first and second bus wires bridged by an electrically conductive positive temperature coefficient (PTC) material; the PTC material can encapsulate and space apart the first and second bus wires, and can form a channel between the first bus wire and the second bus wire. The second heating cable can be disposed between the first bus wire and the second bus wire at least partially within the channel.

The at least one polymer jacket can include a first polymer jacket surrounding the first heating cable and the second heating cable and comprising a dielectric material, and a second polymer jacket surrounding the first polymer jacket and forming an exterior surface of the dual-heater heating cable, the first heating cable providing the thermal energy to heat an object in contact with the exterior surface; the dual-heater heating cable can further include a ground layer disposed between the first polymer jacket and the second polymer jacket, the first polymer jacket providing dielectric separation between the first and second heating cables and the ground layer. The first and second heating cables can each electrically connect to power controller circuitry that electrically connects to a power supply and is configured to provide power to the second heating cable for a predetermined amount of time before providing power to the first heating cable, the predetermined amount of time being selected to cause the second heating cable to heat the core of tho first heating cable to a threshold temperature that prevents an inrush current within the first heating cable when the first heating cable is energized.

### DESCRIPTION OF THE DRAWINGS

FIG. 1 is a perspective view of a dual heating cable that includes a self-regulating heating cable and a constant wattage (CW) heating cable.

FIG. 2 is an illustrative block diagram showing a system in which a dual heating cable that includes a self-regulating heating cable and a CW heating cable may be implemented.

FIG. 3 is an illustrative flow chart showing a process by which a dual heating cable that includes a self-regulating heating cable and a CW heating cable may be operated.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

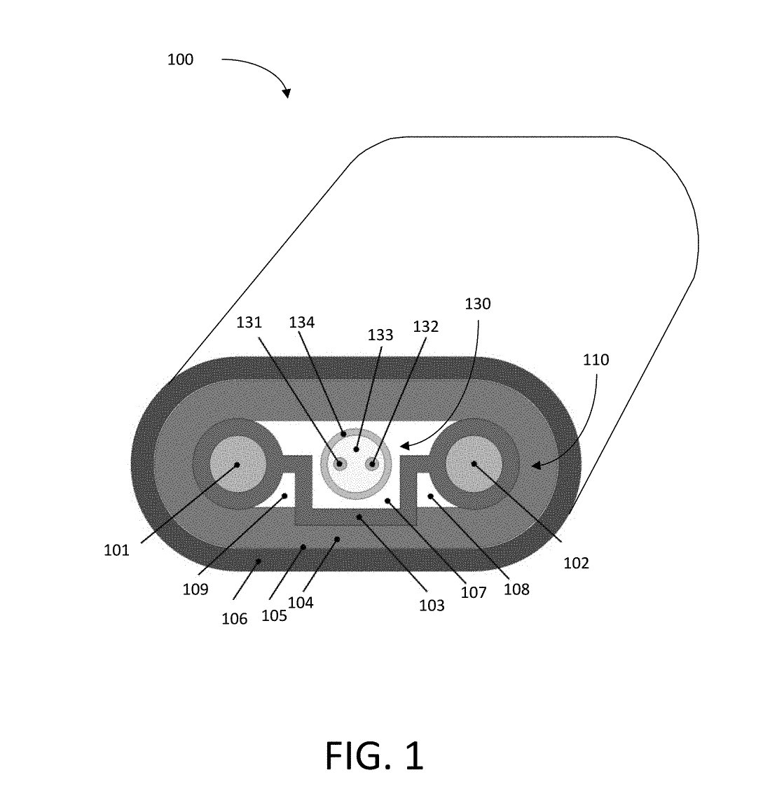

FIG. 1 shows a perspective view of a dual heating cable 100, which includes a self-regulating (SR) heating cable 110 and a constant wattage (CW) heating cable 130. Dual heating cable 100 may be used to provide heat to a variety of objects, such as walkways, pipes, hand-rails, etc. When used in cold/polar environments, low ambient temperatures may contribute to undesirably low internal resistance for PTC conductive polymer within SR heating cable 110, which may contribute to an increased in-rush current when power is initially applied to SR heating cable 110. CW heating cable 130 may be used to perform pre-heating of SR heating cable 110 in order to help mitigate this temperature-related resistance decrease, thereby increasing the resistance of PTC conductive polymer in SR heating cable 110 while decreasing the magnitude of in-rush current flow experienced by SR heating cable 110 at start-up. The maximum length that can be used for an SR heating cable (e.g., at which the SR heating cable is still reliable) is at least partially dependent on the amount of in-rush current that the circuit breaker allows. By mitigating or eliminating the contributions of low temperatures to in-rush current in SR heating cable 110 through pre-heating, longer cable length can be used for SR heating cable 110 without the need for increasing infrastructure current capacity (i.e. increasing circuit breaker size).

SR heating cable 110 includes first and second conductors 101 and 102, which are encapsulated within a positive thermal coefficient (PTC) conductive (e.g., electrically conductive) polymer material 103, which makes up the core of SR heating cable 110. First and second conductors 101 and 102 may act as bus wires that are bridged by PTC conductive polymer material 103. PTC conductive polymer material 103 may, for example, include polymers. In some embodiments, the polymers that make up PTC conductive polymer material 103 may form a contiguous solid (e.g., monolithic), while in other embodiments, these polymers may include multiple fibers (e.g., in a polymeric fiber wrap). As shown, PTC conductive polymer material 103 may be shaped so as to form a channel centered directly between first and second conductors 101 and 102.

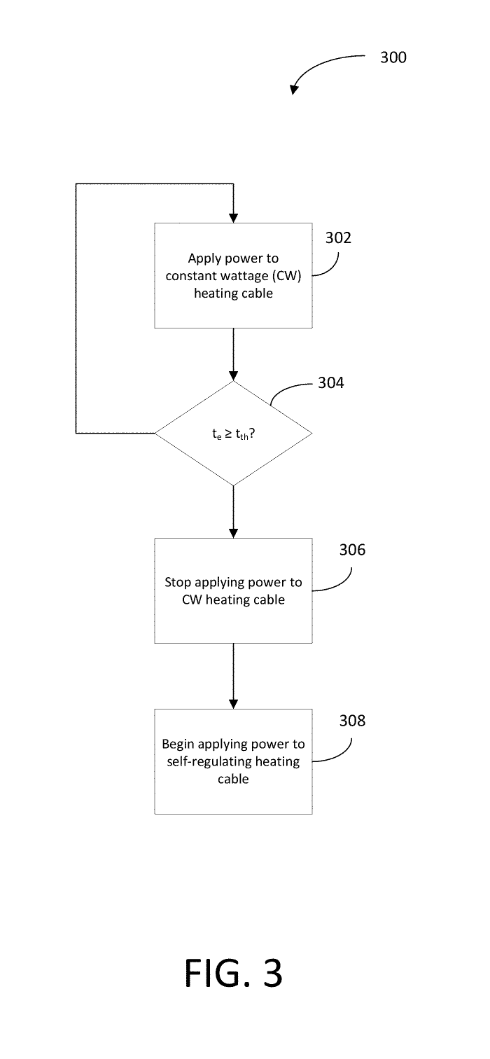

CW heating cable 130 includes third and fourth conductors 131 and 132, which are encapsulated in dielectric material 133. In other embodiments, CW heating cable may only include a single conductor, or may include more than two conductors. Third and fourth conductors 131 and 132 may have the same intrinsic resistance, or may have respectively different intrinsic resistances (e.g., as a result of having different diameters and/or of being formed from different materials). A sheath 134 may be disposed around dielectric material 133 in order to provide environmental protection for CW heating cable 130. CW heating cable 130 may be disposed in close proximity to SR heating cable 110. For example, CW heating cable 130 may be located in the channel formed by PTC conductive polymer material 103 so that heat generated by CW heating cable 130 may be more effectively spread to PTC conductive polymer material 103 during the pre-heating process (e.g., steps 302 and 304 of process 300 of FIG. 3). In this way, the surface area of the interface for heat transfer between PTC conductive polymer material 103 and CW heating cable 130 may be effectively increased compared to embodiments in which no such channel is formed by PTC conductive polymer material 103. The channel formed by PTC conductive polymer material 103 allows for a more compact design of the dual heating cable 100, at least because this channel may accommodate CW heating cable 130. CW heating cable 130 may be arranged loosely in an air-gap adjacent to SR heating cable 110, or may be attached (e.g., affixed) to one or more portions of SR heating cable 110. Additionally, the length of the path of current flow between the first and second conductors 101 and 102 through PTC conductive polymer material 103 may be increased for embodiments in which PTC conductive polymer 103 bends to form a channel compared embodiments in which such a channel is not formed, which may decrease the average electric field produced during the operation of SR heating cable 110.

While the shape of PTC conductive polymer material 103 is shown here as forming a channel, it should be noted that this is intended to be illustrative and not limiting. For example, in some embodiments PTC conductive polymer material 103 may form a “V” shape extending between first and second conductors 101 and 102.

A first thin polymer jacket 104 may be arranged surrounding CW heating cable 130 and SR heating cable 110 to provide dielectric separation between the heating cables and a ground layer 105, which may be wrapped (or otherwise disposed) around first thin polymer jacket 104. Ground layer 105 may be, for example, a metallic foil wrap or an assembly of small strands of drain wires. Ground layer 105 may provide an earth ground for dual heating cable 100 and may provide additional heat transfer around the circumference of the dual heating cable 100. A second thin polymer jacket 106 may be arranged surrounding ground layer 105 and may provide environmental protection for dual heating cable 100. Second thin polymer jacket 106 may include reinforcing fibers to provide additional environmental protection.

Air gaps 107, 108, and 109 may be present in dual heating cable 100 within first thin polymer jacket 104. The size and location of these air gaps may vary depending on the shape and arrangement of SR heating cable 110 and CW heating cable 130.

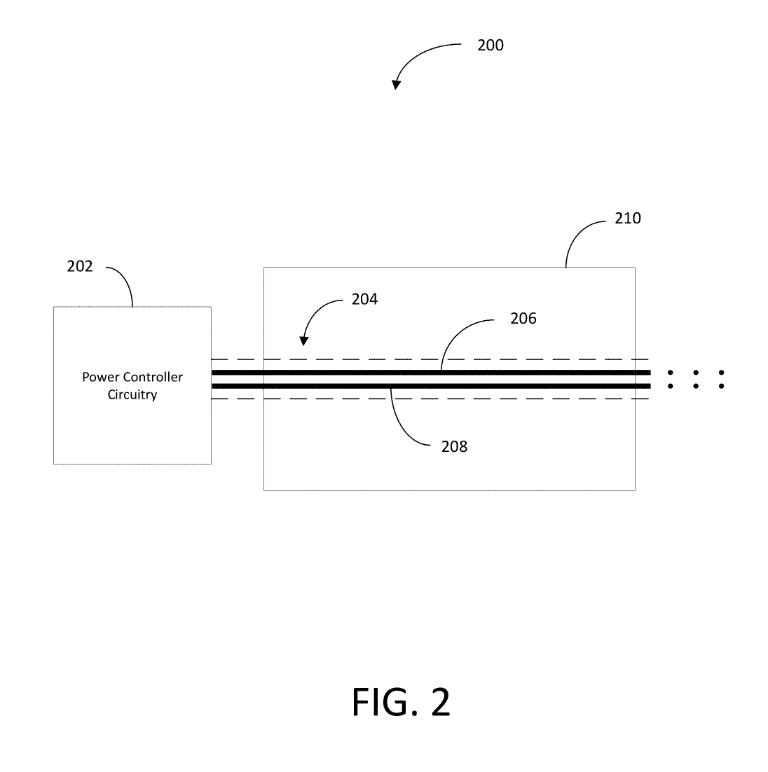

Turning now to FIG. 2, an illustrative block diagram is shown, which includes a system 200 in which, for example, a dual heating cable (e.g., dual heating cable 100 of FIG. 1) may be implemented. System 200 includes power controller circuitry 202, and a dual heating cable 204, which includes a CW heating cable 206 and a SR heating cable 208.

During operation, power control circuitry 202 may provide power to CW heating cable 206 and SR heating cable 208. During a pre-heating process, power control circuitry 202 may provide power to only CW heating cable 206, which may cause CW heating cable 206 to generate heat, thereby warming SR heating cable 208. This pre-heating process may increase the temperature of PTC conductive polymer material (e.g., PTC conductive polymer material 103 of FIG. 1) of SR heating cable 208, thereby increasing the internal resistance of SR heating cable 208, which may result in decreased magnitude of in-rush current observed at SR heating cable 208 when SR heating cable 208 first receives power from power control circuitry 202. For example, the pre-heating process may be performed for a specified (e.g., predetermined or user-defined) amount of time (e.g., 5 minutes) before power is applied to SR heating cable 208. Processing circuitry (e.g., a central processing unit or any other appropriate type of hardware processor) within power controller circuitry 202 or communicatively coupled to power controller circuitry 202 may track the amount of elapsed time since the beginning of the pre-heating process, and may automatically end the pre-heating process upon detecting that the specified amount of time has elapsed, and power controller circuitry 202 may subsequently begin applying power to SR heating cable 208.

As shown, dual heating cable 204 may be disposed in proximity to an object 210, which is intended to be heated by dual heating cable 204. For example, heating cable 204 may be affixed to one or more surfaces (interior and/or exterior) of object 210 and may be arranged in a serpentine pattern on a surface of object 210, wrapped helically around object 210, or provided in any other appropriate arrangement for providing heat to object 210. Object 210 may be, for example, be a walkway, a pipe, a handrail, or any other object that may require heating. Dual heating cable 204 may not be limited to heating only a single object 210, but may extend to further provide heat to multiple objects during operation.

Turning now to FIG. 3, an illustrative process flow chart showing a method 300 for the operation of a dual heating cable (e.g., dual heating cable 100, 204, FIGS. 1, 2) is shown.

At step 302, power may be applied to a CW heating cable (e.g., CW heating cable 130, 206, FIGS. 1, 2) in the dual heating cable in order to pre-heat a SR heating cable (e.g., SR heating cable 110, 208, FIGS. 1, 2) before power is applied to the SR heating cable. For example, power may be supplied to the CW heating cable by a power supply included in or coupled to power controller circuitry (e.g., power controller circuitry 202, FIG. 2).

At step 304, a time elapsed value tₑ may be compared (e.g., using the power controller circuitry) to a time threshold value tₜₕ in order to determine whether the amount of time that has elapsed since power was initially applied to the CW heating cable exceeds a specified amount of time for which the pre-heating process is intended to run. Time threshold value tₜₕ may be stored in a non-transitory computer readable storage medium within or communicatively coupled with the power controller circuitry. Time threshold value tₜₕ may be a predetermined value, or may be a user-defined value. Processing circuitry within the power controller circuitry may continuously track the amount of time elapsed since power was initially applied to the CW heating cable (e.g., using a counter or a timer circuit) and may update the time elapsed value tₑ accordingly. If tₑ is greater than or equal to tₜₕ, it is determined that the pre-heating process has run for the specified amount of time and method 300 may proceed to step 306. Otherwise, if tₑ is less than tₜₕ, it is determined that the pre-heating process should continue, and method 300 may return to step 302 to continue applying power to the CW heating cable.

At step 306, the CW heating cable stops receiving power in response to detecting that the specified amount of time allotted for pre-heating has elapsed. For example, the power controller circuitry may operate a switch to disconnect the CW heating cable from the power supply.

At step 307, power is applied to the SR heating cable. For example, the power controller circuitry may operate a switch to connect the SR heating cable to a power supply (e.g., which may be the same power supply or a different power supply as was used to provide power to the CW heating cable). As a result of the pre-heating provided by the CW heating cable, in-rush current experienced by the SR heating cable when first supplied with power may be reduced, compared to in-rush current that would be experienced without pre-heating.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

What is claimed is:

1. An apparatus comprising:
a dual-heater heating cable comprising:
a first heating cable that includes first and second conductors and heats an area external to the dual-heater heating cable by converting an electric current applied to the first conductor into thermal energy; and
a second heating cable that includes third and fourth conductors, wherein the second heating cable is interposed between the first and second conductors of the first heating cable.

2. The apparatus of claim 1, wherein the first heating cable is a self-regulating heating cable, and wherein the second heating cable is a constant wattage heating cable.

3. The apparatus of claim 1, wherein the first heating cable comprises conductive polymer material that encapsulates the first and second conductors and that electrically couples the first and second conductors together.

4. The apparatus of claim 3, wherein the second heating cable is disposed in a channel of the conductive polymer material.

5. The apparatus of claim 1, wherein the dual-heater heating cable further comprises:
a first polymer jacket surrounding the first heating cable and the second heating cable;
a ground layer surrounding the first polymer jacket; and
a second polymer jacket surrounding the ground layer and forming an exterior surface of the dual-heater heating cable.

6. The apparatus of claim 1, further comprising power controller circuitry that electrically connects to a power supply and to the first and second heating cables, the power controller circuitry configured to provide power to the second heating cable for a predetermined amount of time before providing power to the first heating cable.

7. The apparatus of claim 6, wherein the predetermined amount of time is selected to cause the second heating cable to heat the first heating cable to a threshold temperature that prevents an inrush current within the first heating cable when the first heating cable is energized.

8. The apparatus of claim 7, wherein the power controller circuitry comprises processor circuitry configured to:
at a start-up time, cause the power controller circuitry to provide power to the second heating cable;
while power is provided to the second heating cable, determine whether the predetermined amount of time has elapsed from the start-up time;
responsive to a determination that the predetermined amount of time has elapsed:
cause the power controller circuitry to disconnect power from the second heating cable; and
cause the power controller circuitry to provide power to the first heating cable.

9. The apparatus of claim 7, wherein the first heating cable is a self-regulating heating cable comprising an electrically conductive positive temperature coefficient (PTC) material that encapsulates and spaces apart the first and second conductors and converts at least a portion of an electric current flowing between the first conductor and the second conductor into thermal energy by resistive heating, and wherein the second heating cable heats the PTC material to a steady-state temperature associated with a resistance of the PTC material that enables the first heating cable to maintain a steady-state current without receiving an inrush current that exceeds the steady-state current.

10. The apparatus of claim 9, wherein the second heating cable is a constant wattage heating cable positioned to emit heat onto the PTC material and comprising:
a dielectric material encapsulating the third and fourth conductors; and
a sheath disposed over the dielectric material.

11. The apparatus of claim 10, wherein the dual-heater heating cable further comprises a first polymer jacket surrounding the first heating cable and the second heating cable, and the second heating cable is disposed in an air gap between the PTC material and the first polymer jacket.

12. The apparatus of claim 10, wherein a portion of the PTC material extending between the first conductor and the second conductor defines a channel, and the second heating cable is disposed at least partially within the channel.

13. The apparatus of claim 10, wherein the dual-heater cable is sufficiently flexible so as to be bent into a serpentine or helical orientation to heat an object external to the dual-heater cable.

14. The apparatus of claim 10, further comprising processor circuitry in electronic communication with the power controller circuitry, and a non-transitory computer readable storage medium accessible by the processor circuitry, storing a time threshold value representing a duration that the second heating cable is energized in order to heat the PTC material to the steady-state temperature, and further storing computer-readable instructions that the processor circuitry executes to:
at a start-up time, cause the power controller circuitry to provide power to the second heating cable;
while power is provided to the second heating cable, determine whether a time elapsed from the start-up time is equal to or greater than the time threshold value;
responsive to a determination that the time elapsed is equal to or greater than the time threshold value:
cause the power controller circuitry to disconnect power from the second heating cable; and
cause the power controller circuitry to provide power to the first heating cable.

15. A dual-heater heating cable comprising:
a first heating cable comprising a self-regulating core that converts an electric current applied to the first heating cable into thermal energy;
a second heating cable positioned to heat the core of the first heating cable; and
at least one polymer jacket surrounding the first heating cable and the second heating cable.

16. The dual-heater heating cable of claim 15, wherein the second heating cable is a constant wattage heating cable positioned to emit heat onto the core and comprising:
at least one conductor;
a dielectric material encapsulating the at least one conductor; and
a sheath disposed over the dielectric material.

17. The dual-heater heating cable of claim 15, wherein the core of the first heating cable comprises first and second bus wires bridged by an electrically conductive positive temperature coefficient (PTC) material.

18. The dual-heater heating cable of claim 17, wherein the PTC material encapsulates and spaces apart the first and second bus wires and forms a channel between the first bus wire and the second bus wire, and the second heating cable is disposed between the first bus wire and the second bus wire at least partially within the channel.

19. The dual-heater heating cable of claim 15, wherein:
the at least one polymer jacket includes:
a first polymer jacket surrounding the first heating cable and the second heating cable and comprising a dielectric material; and
a second polymer jacket surrounding the first polymer jacket and forming an exterior surface of the dual-heater heating cable, the first heating cable providing the thermal energy to heat an object in contact with the exterior surface; and
the dual-heater heating cable further comprises a ground layer disposed between the first polymer jacket and the second polymer jacket, the first polymer jacket providing dielectric separation between the first and second heating cables and the ground layer.

20. The dual-heater heating cable of claim 15, wherein the first and second heating cables each electrically connect to power controller circuitry that electrically connects to a power supply and is configured to provide power to the second heating cable for a predetermined amount of time before providing power to the first heating cable, the predetermined amount of time being selected to cause the second heating cable to heat the core of the first heating cable to a threshold temperature that prevents an inrush current within the first heating cable when the first heating cable is energized.
